(19) United States
(12) Patent Application Publication
(10) Pub. No.: US 2022/0194170 A1
(43) Pub. Date: Jun. 23, 2022

(54) VEHICLE VENTILATION DEVICE

(71) Applicant: TOYOTA JIDOSHA KABUSHIKI KAISHA, Toyota-shi Aichi-ken (JP)

(72) Inventor: Sokfan Yee, Toyota-shi Aichi-ken (JP)

(73) Assignee: TOYOTA JIDOSHA KABUSHIKI KAISHA, Toyota-shi Aichi-ken (JP)

(21) Appl. No.: 17/485,902

(22) Filed: Sep. 27, 2021

(30) Foreign Application Priority Data
Dec. 22, 2020 (JP) 2020-212465

(51) Int. Cl. B60H 1/00

(52) U.S. Cl. CPC B60H 1/00742; B60H 1/00828

(57) ABSTRACT

A vehicle ventilation device includes: a calculation unit that calculates at least one of an occupant density and a mask wearing rate in a vehicle based on a detection result of a sensor; and a ventilation control unit that ventilates an inside of the vehicle in accordance with at least one of the occupant density and the mask wearing rate calculated by the calculation unit.

### CROSS-REFERENCE TO RELATED APPLICATION

This application claims priority to Japanese Patent Application No. 2020-212465 filed on Dec. 22, 2020, incorporated herein by reference in its entirety.

### BACKGROUND

### 1. Technical Field

The present disclosure relates to a vehicle ventilation device.

### 2. Description of Related Art

Japanese Unexamined Patent Application Publication No. 09-066730 (JP 09-066730 A) discloses a ventilation device for a vehicle. The ventilation device includes a sensor and a drive unit. The sensor detects a state in which the temperature inside the vehicle rises to be equal to or more than a set value and outputs a detection signal. The drive unit ventilates the inside of the vehicle in response to the outside air temperature by using the detection signal from the sensor as a start command.

### SUMMARY

By the way, depending on a virus, the infection route may be airborne infection or droplet infection. It has been pointed out that in a poorly ventilated space, the virus concentration in the air may increase, which may pose a risk of infection. That is, since there is a situation in which ventilation should be performed even if the temperature inside the vehicle is low, there is room for improvement in the ventilation device described in JP 09-066730 A from the viewpoint of measures against virus infectious diseases. The present disclosure provides a technique capable of reducing the risk of viral infection resulting from airborne infection or droplet infection.

A vehicle ventilation device according to one aspect of the present disclosure includes: a calculation unit that calculates at least one of an occupant density and a mask wearing rate in a vehicle based on a detection result of a sensor; and a ventilation control unit that ventilates an inside of the vehicle in accordance with at least one of the occupant density and the mask wearing rate calculated by the calculation unit.

In this vehicle ventilation device, the calculation unit calculates at least one of the occupant density and the mask wearing rate in the vehicle based on a detection result of a sensor. Then, the ventilation control unit ventilates the inside of the vehicle in accordance with at least one of the occupant density and the mask wearing rate. In this way, at least one of the occupant density and the mask wearing rate can be used for determination of ventilation inside the vehicle. Therefore, the vehicle ventilation device can reduce the risk of viral infection caused by airborne infection or droplet infection.

In one embodiment, the ventilation control unit may perform ventilation so that the higher the occupant density or the lower the mask wearing rate, the greater a ventilation volume. The higher the occupant density or the lower the mask wearing rate, the higher the virus concentration in the air may be. Thus, ventilation is further required. Ventilation is performed so that the higher the occupant density or the lower the mask wearing rate, the greater the ventilation volume. Thus, efficient measures against viral infections can be realized, and ventilation volume can be suppressed when the occupant density is low or when the mask wearing rate is high. Therefore, it is possible to properly maintain the temperature inside the vehicle cabin.

In one embodiment, the ventilation control unit may include: a risk level calculation unit that calculates an infection risk level based on the occupant density and the mask wearing rate calculated by the calculation unit; and a device control unit that performs at least one of a control of an air conditioning device of the vehicle and an opening and closing control of a window based on the infection risk level calculated by the risk level calculation unit. In this case, the risk level calculation unit calculates the infection risk level based on the occupant density and the mask wearing rate. Then, based on the infection risk level, at least one of the control of the air conditioning device of the vehicle and the opening and closing control of the window is performed. By evaluating the infection risk level by using two indicators that are the occupant density and the mask wearing rate, the infection risk level can be accurately evaluated as compared with the case where the infection risk level is evaluated using either the occupant density or the mask wearing rate. Therefore, the vehicle ventilation device can reduce the risk of viral infection caused by airborne infection or droplet infection.

In one embodiment, the risk level calculation unit may calculate a first infection risk level to be higher as the occupant density increases and calculate a second infection risk level to be higher as the mask wearing rate decreases, and may calculate the infection risk level based on the first infection risk level and the second infection risk level, and the device control unit may perform at least one of the control of the air conditioning device of the vehicle and the opening and closing control of a window based on the infection risk level calculated by the risk level calculation unit. In this case, the vehicle ventilation device can more accurately assess the infection risk level.

In one embodiment, the vehicle ventilation device may include an output unit that outputs a signal requesting a boarding reservation system to limit a reservation when the infection risk level is equal to or higher than a threshold. In this case, the vehicle ventilation device can suppress the infection risk level from further increasing due to the increase in the number of occupants, in a situation where the infection risk level is high to some extent.

According to the present disclosure, the risk of viral infection due to airborne infection or droplet infection can be reduced.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a functional block diagram of an example of a vehicle including a vehicle ventilation device according to an embodiment;

FIG. 2 is a flowchart showing an example of an operation of the vehicle ventilation device according to the embodiment;

FIG. 3 is a flowchart showing an example of a first infection risk level calculation process;

FIG. 4 is a flowchart showing an example of a second infection risk level calculation process;

FIG. 5A is data in which a level of occupant density and the first infection risk level are associated with each other;

FIG. 5B is data in which a level of mask wearing rate and the second infection risk level are associated with each other; and

FIG. 5C is data in which an infection risk level, a ventilation volume, and a reservation restriction request are associated with each other.

### DETAILED DESCRIPTION OF EMBODIMENTS

Hereinafter, an exemplary embodiment will be described with reference to the drawings. In the following description, the same or corresponding elements will be denoted by the same reference symbols, and overlapping description will not be repeated.

Vehicle and Vehicle Ventilation Device Configuration

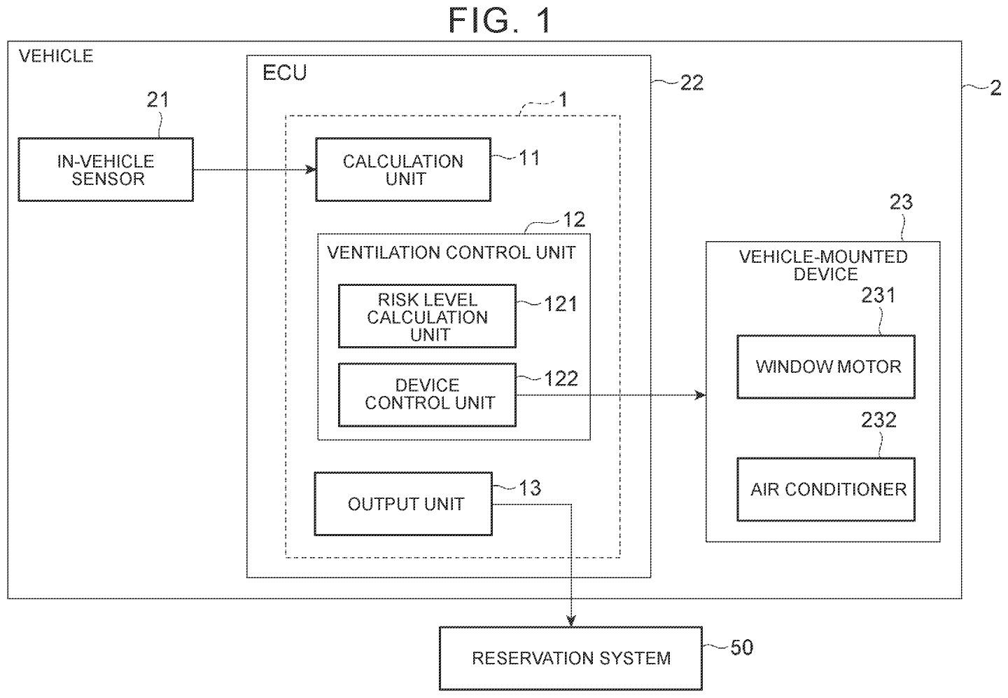

FIG. 1 is a functional block diagram of an example of a vehicle including a vehicle ventilation device according to an embodiment. As shown in FIG. 1, a vehicle ventilation device 1 is a device that is mounted on a vehicle 2 such as a bus, a taxi, or a general passenger car and that controls ventilation in the vehicle. The vehicle 2 may be a vehicle that travels by autonomous driving, or may be a vehicle that travels by driving performed by a driver. The vehicle 2 includes an in-vehicle sensor 21 (an example of a sensor), an electronic control unit (ECU) 22, and a vehicle-mounted device 23.

The in-vehicle sensor 21 is a device that detects the situation inside the vehicle. An example of the situation inside the car is the number of occupants. The device for detecting the number of occupants is, for example, a camera including an image sensor for capturing an image of the inside of the vehicle and an image processing unit having an image recognition function. The device for detecting the number of occupants may be a seating sensor, a motion sensor provided at a doorway, an infrared sensor, or the like. An example of the situation inside the vehicle is the distinction between an occupant wearing a mask and an occupant not wearing a mask. The device for detecting such a situation is, for example, a camera including an image sensor for capturing an image of the inside of the vehicle and an image processing unit having an image recognition function. A plurality of the in-vehicle sensors 21 may be provided for one vehicle.

The vehicle-mounted device 23 is provided in the vehicle 2 and is a device related to ventilation. Here, ventilation means to make the air inside the vehicle cabin flow regardless of the presence or absence of taking in outside air. The vehicle-mounted device 23 includes a window motor 231 and an air conditioner 232. The window motor 231 is an actuator that opens and closes a window of the vehicle 2, and operates based on an instruction signal of the ECU 22. The air conditioner 232 is an air conditioning device that adjusts the temperature of the air in the vehicle cabin while blowing air, circulating air, or taking in outside air. The air conditioner 232 may have a function of adjusting humidity and a function of disinfecting bacteria.

The ECU 22 controls ventilation. The ECU 22 is an electronic control unit including a central processing unit (CPU), a read only memory (ROM), a random access memory (RAM), a controller area network (CAN), and the like. The ECU 22 is connected to a network that communicates using, for example, a CAN communication circuit, and is communicably connected to the above-described components of the vehicle 2. The ECU 22 realizes a control related to ventilation by, for example, operating a CAN communication circuit to input/output data based on a signal output by the CPU, storing the data in the RAM, and executing a program stored in the ROM. The ECU 22 may load the program into the RAM and execute the program loaded in the RAM to realize control related to ventilation. The ECU 22 may be composed of a plurality of electronic units.

The ECU 22 is connected to the in-vehicle sensor 21 and the vehicle-mounted device 23 to communicate information with each other. The ECU 22 includes a calculation unit 11, a ventilation control unit 12, and an output unit 13.

The calculation unit 11 acquires the detection result of the in-vehicle sensor 21, and calculates at least one of an occupant density in the vehicle and a mask wearing rate based on the detection result of the in-vehicle sensor 21. The calculation unit 11 calculates the occupant density by dividing the number of occupants detected by the in-vehicle sensor 21 by a ridable area. The calculation unit 11 calculates the mask wearing rate by dividing the number of people wearing the mask detected by the in-vehicle sensor 21 by the number of occupants.

The ventilation control unit 12 ventilates the inside of the vehicle in accordance with at least one of the occupant density and the mask wearing rate calculated by the calculation unit 11. The ventilation control unit 12 performs ventilation so that the higher the occupant density calculated by the calculation unit 11, the greater the ventilation volume. Alternatively, the ventilation control unit 12 performs ventilation so that the lower the mask wearing rate calculated by the calculation unit 11, the greater the ventilation volume. The ventilation volume is the amount of air made to flow.

The ventilation control unit 12 calculates an infection risk level when determining the necessity of ventilation by using both the occupant density and the mask wearing rate. The infection risk level is an index showing the degree of infection risk. In this case, the ventilation control unit 12 includes a risk level calculation unit 121 for calculating the infection risk level. The risk level calculation unit 121 calculates the infection risk level based on the occupant density and the mask wearing rate calculated by the calculation unit 11. The risk level calculation unit 121 calculates a first infection risk level to be higher as the occupant density increases, and calculates a second infection risk level to be higher as the mask wearing rate decreases. The risk level calculation unit 121 calculates an infection risk level based on the first infection risk level and the second infection risk level. For example, the risk level calculation unit 121 can calculate the infection risk level by adding the first infection risk level and the second infection risk level.

A device control unit 122 performs at least one of the control of the vehicle-mounted device 23 of the vehicle 2 and the opening and closing control of the window based on the infection risk level calculated by the risk level calculation unit 121. For example, the device control unit 122 may determine the drive amount of the window motor 231 and the air volume and the outside air intake amount of the air conditioner 232 in accordance with the magnitude of the infection risk level, and may output an instruction signal to the vehicle-mounted device 23.

When the infection risk level is equal to or higher than a threshold, the output unit 13 outputs a signal requesting a reservation system 50 (an example of a boarding reservation system) to limit the reservation. Here, the reservation means a boarding reservation. The reservation system 50 is a system that provides a boarding reservation for the vehicle 2. The user can reserve the boarding of the vehicle 2 by designating, for example, the date, time, and place through the reservation system 50. The threshold is a preset infection risk level for determining reservation limits. Upon receiving the signal requesting that the reservation be restricted, the reservation system 50 suspends the acceptance of the boarding reservation of the vehicle 2. This makes it possible to limit the number of new people boarding the vehicle 2.

Operation of Vehicle Ventilation Device

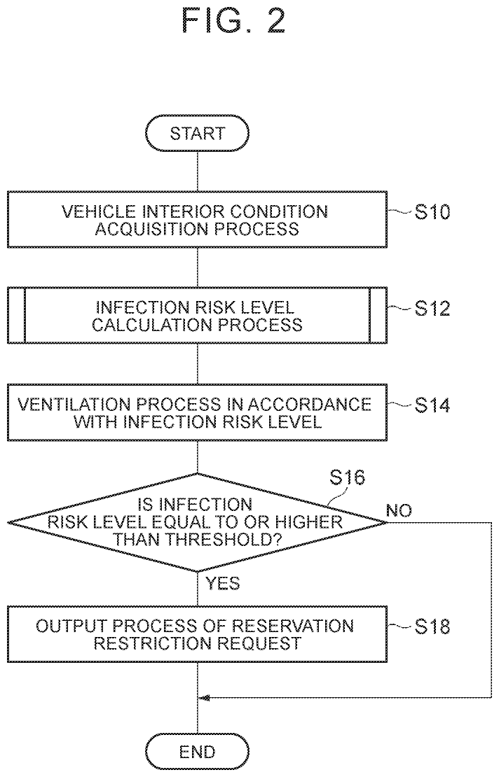

FIG. 2 is a flowchart showing an example of an operation of the vehicle ventilation device according to the embodiment. The flowchart shown in FIG. 2 is executed by the vehicle ventilation device 1 at the timing when the automatic ventilation button provided in the vehicle 2 is turned on.

As shown in FIG. 2, the calculation unit 11 of the vehicle ventilation device 1 acquires the detection result of the in-vehicle sensor 21 as the vehicle interior condition acquisition process (step S10). The calculation unit 11 acquires the number of occupants and the number of people wearing masks from the in-vehicle sensor 21.

Subsequently, the calculation unit 11 first calculates the occupant density and the mask wearing rate as the infection risk level calculation process (step S12). Then, the calculation unit 11 calculates the first infection risk level from the occupant density, and calculates the second infection risk level from the mask wearing rate. Then, the calculation unit 11 adds the first infection risk level and the second infection risk level to calculate the final infection risk level.

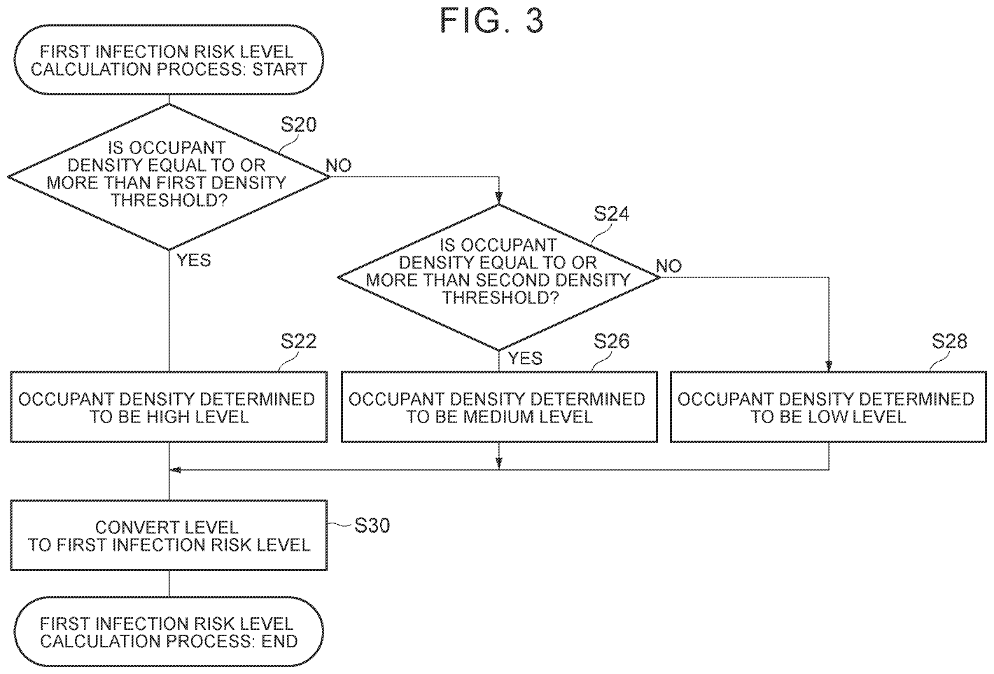

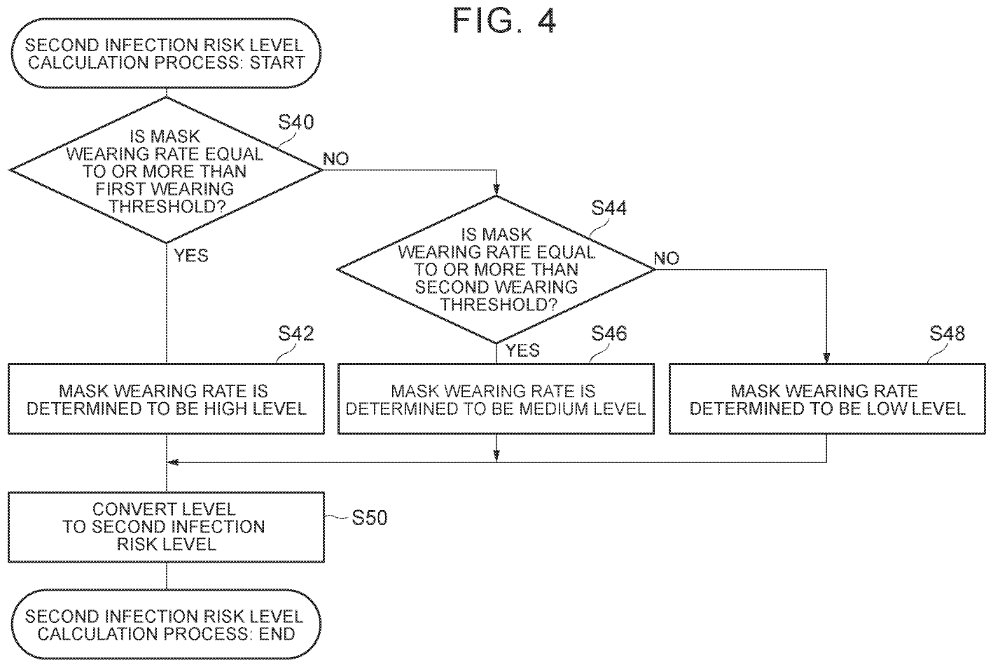

FIG. 3 and FIG. 4 show the details of step S12 described above. First, an example of calculating the first infection risk level based on the occupant density will be described. FIG. 3 is a flowchart showing an example of a first infection risk level calculation process. As shown in FIG. 3, the calculation unit 11 determines whether the occupant density is equal to or more than a first density threshold as the determination process (step S20). The first density threshold is a preset occupant density for determining whether the occupant density is at a high level. When it is determined that the occupant density is equal to or more than the first density threshold (S20: YES), the calculation unit 11 determines that the occupant density is a “high level”, as step S22.

When it is determined that the occupant density is not equal to or more than the first density threshold (S20: NO), the calculation unit 11 determines whether the occupant density is equal to or more than the second density threshold as a determination process (step S24). The second density threshold is a preset occupant density for determining whether the occupant density is at a medium level, and is a value smaller than the first density threshold. When it is determined that the occupant density is equal to or more than the second density threshold (S24: YES), the calculation unit 11 determines that the occupant density is a “medium level” in step S26. When it is determined that the occupant density is not equal to or more than the second density threshold (S24: NO), the calculation unit 11 determines that the occupant density is a “low level” in step S28.

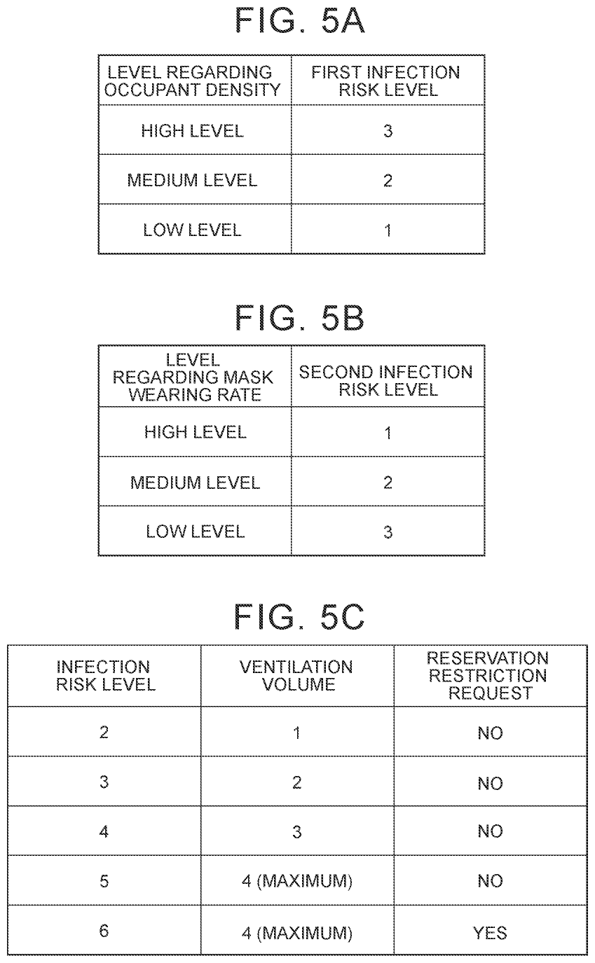

When step S22, step S26 or step S28 is completed, the calculation unit 11 converts the level into the first infection risk level as step S30. FIG. 5A is data in which the level of occupant density is associated with the first infection risk level. This data is stored in advance in, for example, a storage unit of the ECU 22. As shown in FIG. 5A, the “high level” is associated with the first infection risk level “3”, and the “medium level” is associated with the first infection risk level “2”, and the “low level” is associated with the first infection risk level “1”. The calculation unit 11 converts the level into the first infection risk level based on the data shown in FIG. 5A. When the process in step S30 is completed, the first infection risk level calculation process ends.

Next, an example of calculating the second infection risk level based on the mask wearing rate will be described. FIG. 4 is a flowchart showing an example of a second infection risk level calculation process. As shown in FIG. 4, the calculation unit 11 determines whether the mask wearing rate is equal to or more than the first wearing threshold as the determination process (step S40). The first wearing threshold is a mask wearing rate set in advance for determining whether the mask wearing rate is at a high level. When it is determined that the mask wearing rate is equal to or more than the first wearing threshold (S40: YES), the calculation unit 11 determines that the mask wearing rate is a “high level” in step S42.

When it is determined that the mask wearing rate is not equal to or more than the first wearing threshold (S40: NO), the calculation unit 11 determines whether the mask wearing rate is equal to or more than the second wearing threshold as a determination process (step S44). The second wearing threshold is a mask wearing rate set in advance for determining whether the mask wearing rate is at a medium level, and is a value smaller than the first wearing threshold. When it is determined that the mask wearing rate is equal to or more than the second wearing threshold (S44: YES), the calculation unit 11 determines that the mask wearing rate is a “medium level” in step S46. When it is determined that the mask wearing rate is not equal to or more than the second wearing threshold (S44: NO), the calculation unit 11 determines that the mask wearing rate is a “low level” in step S48.

When step S42, step S46 or step S48 is completed, the calculation unit 11 converts the level into the second infection risk level as step S50. FIG. 5B is data in which the level regarding the mask wearing rate and the second infection risk level are associated with each other. This data is stored in advance in, for example, a storage unit of the ECU 22. As shown in FIG. 5B, the “high level” is associated with the second infection risk level “1”, and the “medium level” is associated with the second infection risk level “2”, and the “low level” is associated with the second infection risk level “3”. The calculation unit 11 converts the level into the second infection risk level based on the data shown in FIG. 5B. When the processing in step S50 is completed, the second infection risk level calculation process ends.

This completes the detailed description of step S12 of FIG. 2. The calculation unit 11 calculates the infection risk level by adding the first infection risk level and the second infection risk level calculated in FIG. 3 and FIG. 4.

Subsequently, the device control unit 122 of the vehicle ventilation device 1 performs at least one of the control of the vehicle-mounted device 23 of the vehicle 2 and the opening and closing control of the window as the ventilation process (step S14) in accordance with the infection risk level. The device control unit 122 determines the ventilation volume in accordance with the infection risk level, controls the air conditioner 232 and/or drives the window motor 231 so as to realize the determined ventilation volume. The device control unit 122 determines the ventilation volume in accordance with the infection risk level, for example, based on the data shown in FIG. 5C. FIG. 5C is data in which an infection risk level, a ventilation volume, and a reservation restriction request are associated with each other. This data is stored in advance in, for example, a storage unit of the ECU 22.

As shown in FIG. 5C, the infection risk level “2” is associated with the ventilation volume “1”, the infection risk level “3” is associated with the ventilation volume “2”, the infection risk level “4” is associated with the ventilation volume “3”, and infection risk levels “5” and “6” are associated with the ventilation volume “4”. The unit and numerical value of the ventilation volume can be set arbitrarily. Here, the maximum ventilation volume of the vehicle 2 is set to “4”, and the ventilation volumes “3”, “2”, and “1” are set to be smaller in order based on the maximum ventilation volume. In the case of the air conditioner 232, the maximum ventilation volume is the maximum air blowing volume. In the case of a window controlled by the window motor 231, the maximum ventilation volume is the maximum opening/closing amount. When the vehicle 2 is provided with a plurality of windows, the maximum ventilation volume may be determined using two indexes, the number of windows opened and closed and the opening/closing amount. The device control unit 122 acquires the ventilation volume corresponding to the infection risk level calculated in step S12 with reference to the data in FIG. 5C. Then, the device control unit 122 performs at least one of the control of the vehicle-mounted device 23 of the vehicle 2 and the opening and closing control of the window so as to realize the determined ventilation volume.

Returning to FIG. 2, the output unit 13 determines whether the infection risk level is equal to or higher than the threshold as the determination process (step S16). When it is determined that the infection risk level is equal to or higher than the threshold (step S16: YES), the output unit 13 transmits the reservation restriction request to the reservation system 50 as the output process of the reservation restriction request (step S18). For example, as shown in FIG. 5C, the ventilation volume of the vehicle 2 becomes the maximum ventilation volume at the time of the infection risk level “5”. Therefore, for example, the threshold for determining whether the reservation restriction request should be output can be set to the infection risk level “6” or higher. As a result, as shown in FIG. 5C, when the infection risk level is “6” or higher, a reservation restriction request is made.

When the output process of the reservation restriction request (step S18) is completed, or when it is determined that the infection risk level is not equal to or higher than the threshold (step S16: NO), the flowchart shown in FIG. 2 ends. When the flowchart shown in FIG. 2 is completed, the vehicle ventilation device 1 executes the flowchart shown in FIG. 2 until the automatic ventilation button provided in the vehicle 2 is turned off.

### Summary of Embodiments

In the vehicle ventilation device 1, the calculation unit 11 calculates at least one of the occupant density and the mask wearing rate in the vehicle based on a detection result of an in-vehicle sensor 21. Then, the ventilation control unit 12 ventilates the inside of the vehicle in accordance with at least one of the occupant density and the mask wearing rate. In this way, at least one of the occupant density and the mask wearing rate can be used for determination of ventilation inside the vehicle. Therefore, the vehicle ventilation device 1 can reduce the risk of viral infection caused by airborne infection or droplet infection.

In the vehicle ventilation device 1, ventilation is performed so that the higher the occupant density or the lower the mask wearing rate, the greater the ventilation volume. Thus, efficient measures against viral infections can be realized, and ventilation volume can be suppressed when the occupant density is low or when the mask wearing rate is high. Therefore, it is possible to properly maintain the temperature inside the vehicle cabin.

In the vehicle ventilation device 1, the risk level calculation unit 121 calculates the infection risk level based on the occupant density and the mask wearing rate. Then, based on the infection risk level, at least one of the control of the air conditioner 232 and the opening and closing control of the window of the vehicle 2 by the window motor 231 is performed. By evaluating the infection risk level by using two indicators that are the occupant density and the mask wearing rate, the infection risk level can be accurately evaluated as compared with the case where the infection risk level is evaluated using either the occupant density or the mask wearing rate. Therefore, the vehicle ventilation device 1 can reduce the risk of viral infection caused by airborne infection or droplet infection.

In the vehicle ventilation device 1, the output unit outputs the signal requesting the reservation system 50 to limit reservations when the infection risk level is equal to or higher than the threshold. Thus, it is possible to suppress the infection risk level from further increasing due to the increase in the number of occupants, in a situation where the infection risk level is high to some extent.

Although various exemplary embodiments have been described above, various omissions, substitutions, and changes may be made without being limited to the above-mentioned exemplary embodiments.

In the above embodiment, an example in which the infection risk degree is calculated from the occupant density in the vehicle and the mask wearing rate based on the detection result of the in-vehicle sensor 21 and ventilation is performed based on the infection risk level has been described. Ventilation may be performed based on either the occupant density or the mask wearing rate in the vehicle. For example, the ventilation control unit 12 may perform ventilation so that the ventilation volume increases as the occupant density increases. Alternatively, the ventilation control unit 12 may perform ventilation so that the ventilation volume increases as the mask wearing rate decreases. In this way, the ventilation control unit 12 can reduce the risk of viral infection due to airborne infection or droplet infection by ventilating the inside of the vehicle in accordance with at least one of the occupant density and the mask wearing rate.

In the above embodiment, the example in which the vehicle ventilation device 1 includes the output unit 13 has been described. However, when the vehicle 2 is not linked with the reservation system, the vehicle ventilation device 1 does not have to include the output unit 13. In addition, the output unit 13 may output a signal requesting the reservation system 50 to limit reservations when there is no change in the conditions inside the vehicle even when ventilation is performed or when the infection risk level is not expected to improve. Further, in the above embodiment, the output unit 13 may output the infection risk level itself to an external system such as the reservation system 50. In this case, an operator of the system can be urged to confirm the detection result of the in-vehicle sensor 21. In addition, in an external system, a passenger trend log can be created by storing the infection risk level in association with time.

In the above embodiment, the infection risk level is calculated by using three levels of the “high level”, the “medium level”, and the “low level”. However, the infection risk level may be two levels, or may be four or more levels.

Further, in the above embodiment, the vehicle ventilation device 1 can stop ventilation at an appropriate timing. Even if the occupant density decreases or the mask wearing rate increases, it takes a certain period of time until the virus concentration in the air decreases. Therefore, the vehicle ventilation device 1 may continue ventilation even if the infection risk level is equal to or less than a safe threshold, and may stop ventilation after a certain period of time has elapsed after the infection risk level is equal to or more than the safe threshold.

Further, in the above embodiment, the vehicle ventilation device 1 may be provided with a human machine interface (HMI), and the occupants in the vehicle may be alerted in accordance with the infection risk level by a voice or video via the HMI. For example, when the vehicle 2 is a bus and the infection risk level is equal to or higher than the threshold, the vehicle ventilation device 1 may alert the outside of the vehicle that the vehicle cannot be boarded by voice or video via the HMI.

What is claimed is:

1. A vehicle ventilation device comprising:
a calculation unit that calculates at least one of an occupant density and a mask wearing rate in a vehicle based on a detection result of a sensor; and
a ventilation control unit that ventilates an inside of the vehicle in accordance with at least one of the occupant density and the mask wearing rate calculated by the calculation unit.

2. The vehicle ventilation device according to claim 1, wherein the ventilation control unit performs ventilation so that the higher the occupant density or the lower the mask wearing rate, the greater a ventilation volume.

3. The vehicle ventilation device according to claim 1, the ventilation control unit comprising:
a risk level calculation unit that calculates an infection risk level based on the occupant density and the mask wearing rate calculated by the calculation unit; and
a device control unit that performs at least one of a control of an air conditioning device of the vehicle and an opening and closing control of a window based on the infection risk level calculated by the risk level calculation unit.

4. The vehicle ventilation device according to claim 3, wherein:
the risk level calculation unit calculates a first infection risk level to be higher as the occupant density increases, and calculates a second infection risk level to be higher as the mask wearing rate decreases, and calculates the infection risk level based on the first infection risk level and the second infection risk level; and
the device control unit performs at least one of the control of the air conditioning device of the vehicle and the opening and closing control of the window based on the infection risk level calculated by the risk level calculation unit.

5. The vehicle ventilation device according to claim 4, further comprising an output unit that outputs a signal requesting a boarding reservation system to limit a reservation when the infection risk level is equal to or higher than a threshold.
